(19) United States
(12) Patent Application Publication
(10) Pub. No.: US 2012/0280127 A1
(43) Pub. Date: Nov. 8, 2012

(54) TWO COLOR SPREAD SPECTRUM OPTICAL ENCODER

(75) Inventors: Martin E. Rosalik, JR., Oakland, MI (US); Thomas R. McBride, Holly, MI (US)

(73) Assignee: GM GLOBAL TECHNOLOGY OPERATIONS LLC, Detroit, MI (US)

(21) Appl. No.: 13/102,145

(22) Filed: May 6, 2011

(51) Int. Cl. G01J 5/10; G01D 5/34

(52) U.S. Cl. 250/338.1; 250/231.14

(57) ABSTRACT

An optical encoder includes a first signal diode that emits light at an infrared wavelength, and a second signal diode that emits a light at a visible blue wavelength. The optical encoder further includes a first sensor diode having an optical wavelength filter for filtering out light having a wavelength outside the infrared wavelength, and a second sensor diode having an optical wavelength filter for filtering out light having a wavelength outside the visible blue wavelength spectrum. A slotted wheel defining a plurality of radially extending slots rotates past the signal diodes and the sensor diodes such that the sensor diodes may sense the light passing through the slots in the slotted wheel.

### TECHNICAL FIELD

The invention generally relates to an optical encoder, and more specifically to an optical quadrature encoder.

### BACKGROUND

Angular positions of continuously rotating devices, such as electric motors or the like, must be sensed in order to properly control the device. The rotating devices often include a rotary encoder to sense the angular position and/or speed of a rotating shaft. In certain types of devices in which a fluid may be present and/or suspended in the air surrounding the rotary encoder, such as but not limited to a vehicle transmission, the rotary encoder may include a Hall Effect sensor, or some other similar magnetic field type encoder. However, these magnetic field type rotary encoders may be negatively affected by the strong magnetic fluxes created near the end windings of powerful motor/generators.

### SUMMARY

An optical encoder is provided. The optical encoder includes a slotted wheel. The slotted wheel defines a plurality of slots extending radially outward from a center of the slotted wheel, and disposed angularly about the center of the slotted wheel. A first signal diode is configured for emitting light at a first wavelength perpendicular to the slotted wheel. A first sensor diode is disposed opposite the slotted wheel from the first signal diode. The first sensor diode is configured for receiving the light emitted from the first signal diode through the plurality of slots. A second signal diode is configured for emitting light at a second wavelength perpendicular to the slotted wheel. The first wavelength is different from the second wavelength. A second sensor diode is disposed opposite the slotted wheel from the second signal diode. The second sensor diode is configured for receiving the light emitted from the second signal diode through the plurality of slots. The slotted wheel is rotatable relative to the first signal diode, the second signal diode, the first sensor diode and the second sensor diode.

An optical encoder is also provided. The optical encoder includes a housing. A slotted wheel is rotatable relative to the housing. The slotted wheel defines a plurality of slots extending radially outward from a center of the slotted wheel, and disposed angularly about the center of the slotted wheel. A first signal diode is attached to the housing. The first signal diode is configured for emitting light at a first wavelength perpendicular to the slotted wheel. The first wavelength includes a wavelength between the range of seven hundred nanometers (700 nm) and fourteen hundred nanometers (1,400 nm). A first sensor diode is disposed opposite the slotted wheel from the first signal diode. The first sensor diode is configured for receiving the light emitted from the first signal diode through the plurality of slots. The first sensor diode includes a first band pass filter that is configured for filtering out light having a wavelength outside the range of seven hundred nanometers (700 nm) and fourteen hundred nanometers (1,400 nm). A second signal diode is attached to the housing. The second signal diode is configured for emitting light at a second wavelength perpendicular to the slotted wheel. The second wavelength includes a wavelength between the range of four hundred fifty nanometers (450 nm) and four hundred ninety nanometers (490 nm). A second sensor diode is disposed opposite the slotted wheel from the second signal diode. The second sensor diode is configured for receiving the light emitted from the second signal diode through the plurality of slots. The second sensor diode includes a second band pass filter that is configured for filtering out light having a wavelength outside the range of four hundred fifty nanometers (450 nm) and four hundred ninety nanometers (490 nm).

An assembly is also provided. The assembly includes an outer shell defining a closed interior. The outer shell rotatably supports a shaft within the closed interior. A fluid is disposed within the closed interior. An optical encoder is also disposed within the closed interior. The optical encoder is coupled to the shaft for sensing a position of the shaft. The optical encoder includes a slotted wheel. The slotted wheel defines a plurality of slots extending radially outward from a center of the slotted wheel, and disposed angularly about the center of the slotted wheel. The slotted wheel is rotatable with the shaft. The optical encoder further includes a first signal diode. The first signal diode is configured for emitting light at a first wavelength perpendicular to the slotted wheel. The first wavelength includes a wavelength between the range of seven hundred nanometers (700 nm) and fourteen hundred nanometers (1,400 nm). The optical encoder further includes a first sensor diode. The first sensor diode is disposed opposite the slotted wheel from the first signal diode. The first sensor diode is configured for receiving the light emitted from the first signal diode through the plurality of slots. The first sensor diode includes a first band pass filter that is configured for filtering out light having a wavelength outside the range of seven hundred nanometers (700 nm) and fourteen hundred nanometers (1,400 nm). The optical sensor further includes a second signal diode. The second signal diode is configured for emitting light at a second wavelength perpendicular to the slotted wheel. The second wavelength includes a wavelength between the range of four hundred fifty nanometers (450 nm) and four hundred ninety nanometers (490 nm). The optical encoder further includes a second sensor diode. The second sensor diode is disposed opposite the slotted wheel from the second signal diode. The second sensor diode is configured for receiving the light emitted from the second signal diode through the plurality of slots. The second sensor diode includes a second band pass filter that is configured for filtering out light having a wavelength outside the range of four hundred fifty nanometers (450 nm) and four hundred ninety nanometers (490 nm).

Accordingly, the optical encoder is suitable for use in non-sealed and/or wet environment, such as a transmission or an electric motor/generator of a hybrid vehicle, and is not adversely effected by a magnetic flux produced by the end windings of the electric motor/generator.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of an assembly having an optical encoder for sensing a position of a shaft.

FIG. 2 is a schematic plan view of a slotted wheel of the optical encoder.

FIG. 3 is an enlarged schematic plan view of the optical encoder.

FIG. 4 is a schematic plan view of an alternative embodiment of the optical encoder.

FIG. 5 is a schematic plan view of an alternative embodiment of the slotted wheel for use with the alternative embodiment of the optical encoder shown in FIG. 4.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

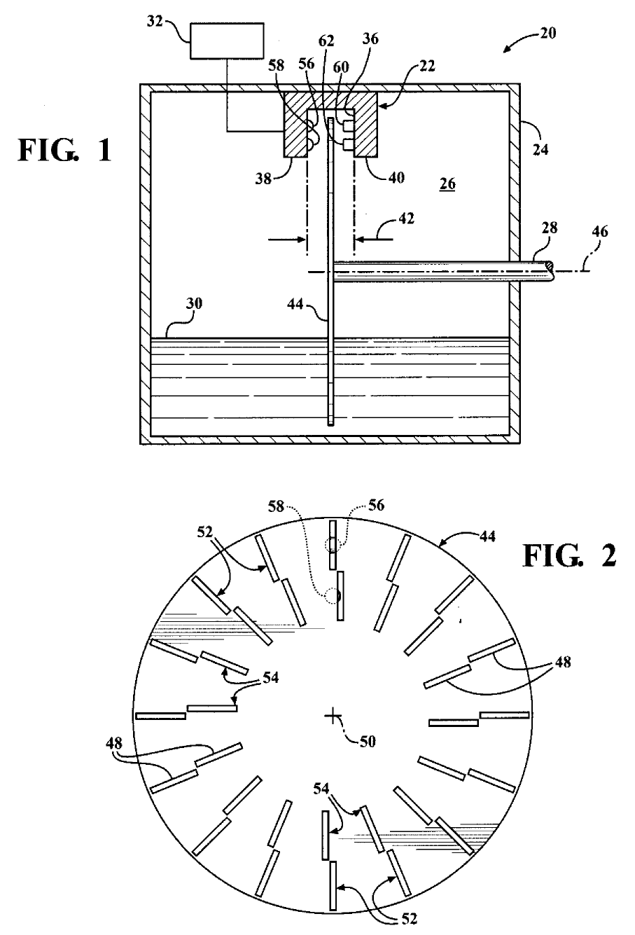

Referring to the Figures, wherein like numerals indicate like parts throughout the several views, an assembly is generally shown at 20 in FIG. 1. The assembly 20 may include any device incorporating an optical encoder 22 therein. For example, the assembly 20 may include a transmission for a vehicle or the like. Referring to FIG. 1, wherein the assembly 20 schematically represents a transmission for a vehicle, the assembly 20 includes an outer shell 24. The outer shell 24 defines a closed interior 26, and rotatably supports a shaft 28 within the closed interior 26. A fluid 30, e.g., transmission fluid 30, is disposed within the closed interior 26 of the outer shell 24.

The optical encoder 22 is disposed within the closed interior 26 of the outer shell 24. The optical encoder 22 is coupled to the shaft 28 for sensing a position of the shaft 28. The optical encoder 22 is coupled to a controller 32. The controller 32 may be integral with and attached to the optical encoder 22, or may be remotely located from the optical encoder 22. The controller 32 provides a voltage source to the optical encoder 22, as well as receives a sensed signal from the optical encoder 22. The controller 32 interprets the sensed signal from the optical controller 32 to determine the location and/or speed of the shaft 28 at any given time. The controller 32 may include any suitable device, including but not limited to a computer, control module, or some other similar device.

The optical encoder 22 includes a housing 34. As shown, the housing 34 is fixedly attached to the outer shell 24 of the assembly 20. However, it should be appreciated that the housing 34 may be formed by and integral with the outer shell 24 of the assembly 20. The housing 34 defines a channel 36. The channel 36 includes a first side portion 38 and a second side portion 40. The second side portion 40 is parallel with and spaced from the first side portion 38 a channel width 42. Preferably, the channel width 42 is between the range of four millimeters (4 mm) and 8 millimeters (8 mm). More preferably, the channel width 42 is approximately equal to six millimeters (6 mm).

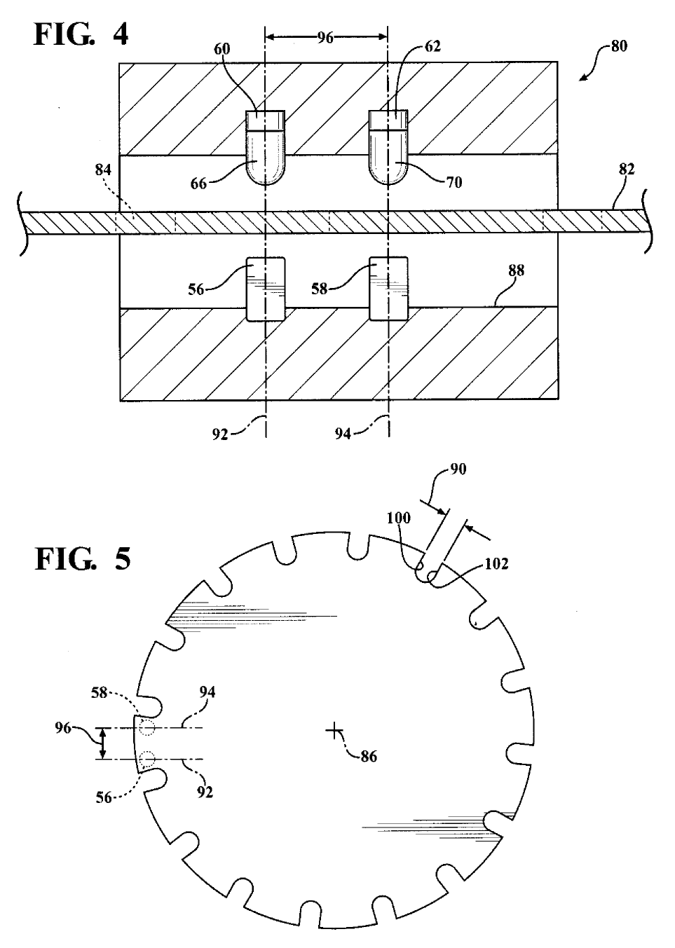

A slotted wheel 44 is rotatably supported relative to the housing 34 and/or the outer shell 24 of the assembly 20. The slotted wheel 44 is rotationally fixed for rotation with the shaft 28 about a longitudinal axis 46 of the shaft 28. As shown, the slotted wheel 44 includes a flat plate. However, it should be appreciated that the slotted wheel 44 may include any shape, such as but not limited to a cylindrical shape. Referring to FIG. 2, the slotted wheel 44 defines a plurality of slots 48. The slots 48 extend radially outward from a center 50 of the slotted wheel 44, and are disposed angularly about the center 50 of the slotted wheel 44. The slots 48 in the slotted wheel 44 rotate through the channel 36 as the slotted wheel 44 rotates with the shaft 28 relative to the housing 34. The plurality of slots 48 includes a first group of slots 52 and a second group of slots 54. The first group of slots 52 is disposed radially farther from the center 50 of the slotted wheel 44 than the second group of slots 54. Furthermore, the first group of slots 52 is angularly offset relative to the second set of slots 48, about the center 50 of the slotted wheel 44. It should be appreciated that the slotted wheel 44 may be configured to include an orientation of the slots 48 that differs from that shown and described herein. For example, the plurality of slots 48 may all be disposed radially equidistant from the center 50 of the slotted wheel 44, such as shown in FIGS. 4 and 5 and described in below.

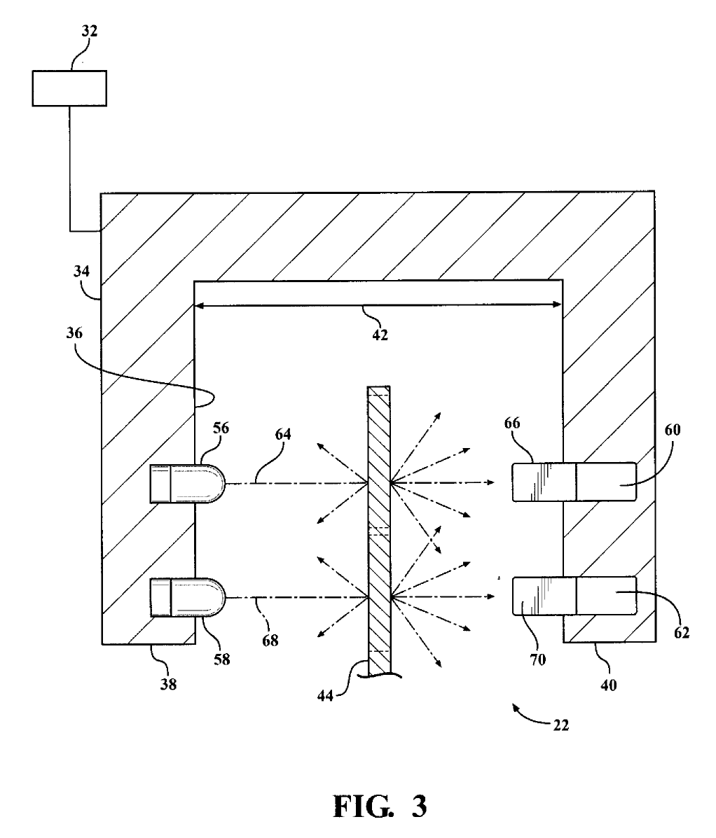

As shown in FIGS. 1 through 3, the optical encoder 22 includes a first signal diode 56 and a second signal diode 58. As shown in FIGS. 1 and 3, the optical encoder 22 further includes a first sensor diode 60 and a second sensor diode 62. As shown, the first signal diode 56 is disposed radially farther from the center 50 of the slotted wheel 44 than the second signal diode 58. Furthermore, the first signal diode 56 is disposed collinearly with the second signal diode 58 along a line extending radially through the center 50 of the slotted wheel 44. Similarly, the first sensor diode 60 is disposed radially farther from the center 50 of the slotted wheel 44 than the second sensor diode 62. Furthermore, the first sensor diode 60 is disposed collinearly with the second sensor diode 62 along a line extending radially through the center 50 of the slotted wheel 44. However, it should be appreciated that the sensor diodes and the signal diodes may be oriented in a configuration other than shown and described herein. For example, the first signal diode 56 and the second signal diode 58 may be radially spaced equidistant from the center 50 of the slotted wheel 44, and angularly spaced from each other, and the first sensor diode 60 and the second sensor diode 62 may be radially spaced equidistant from the center 50 of the slotted wheel 44, and angularly spaced from each other.

The slots 48 in the slotted wheel 44 provide an on-off signal condition between the first signal diode 56 and the first sensor diode 60, as well as between the second signal diode 58 and the second sensor diode 62. As such, the optical encoder 22 is capable of providing two outputs, i.e., one from the first sensor diode 60 and another from the second sensor diode 62. The optical encoder 22 may therefore be referred to as a quadrature encoder.

Referring also to FIG. 3, the first signal diode 56 is attached to the housing 34. More specifically, the first signal diode 56 is attached to the first side portion 38 of the housing 34. The first signal diode 56 is configured for emitting light at a first wavelength 64, perpendicular to the slotted wheel 44. Accordingly, the light emitted from the first signal diode 56 passes through slots 48 in the slotted wheel 44 as the slotted wheel 44 rotates past the housing 34 and the first signal diode 56.

The first sensor diode 60 is disposed opposite the slotted wheel 44 from the first signal diode 56. The first sensor diode 60 is attached to the housing 34. More specifically, the first sensor diode 60 is attached to the second side portion 40 of the housing 34. The first sensor diode 60 is configured for receiving the light emitted from the first signal diode 56 through the plurality of slots 48. Because the first sensor diode 60 is directly opposite the first signal diode 56, the first sensor diode 60 only receives light from the first signal diode 56 when one of the slots 48 is directly between the first signal diode 56 and the first sensor diode 60. As shown, the first signal diode 56 and the first sensor diode 60 are disposed across the first group of slots 52, such that light emitted from the first signal diode 56 must pass through the first group of slots 52 to reach the first sensor diode 60.

The first signal diode 56 may include, but is not limited to, a Light Emitting Diode (LED). The first signal diode 56 emits an infrared light having a wavelength between seven hundred nanometers (700 nm) and fourteen hundred nanometers (1,400 nm). Preferably, the first signal diode 56 emits a light having a wavelength approximately equal to eight hundred seventy nanometers (870 nm).

The first sensor diode 60 includes a PIN diode. The first sensor diode 60 further includes a wavelength filter, such as but not limited to a first band pass filter 66. The first band pass filter 66 is configured to filter out light that is outside the infrared range. Preferably, the first band pass filter 66 filters out light having a wavelength outside the range of seven hundred nanometers (700 nm) and fourteen hundred nanometers (1,400 nm). Accordingly, only light having a wavelength between the range of seven hundred nanometers (700 nm) and fourteen hundred nanometers (1,400 nm) may pass through the first band pass filter 66 and reach the PIN diode of the first sensor diode 60.

The second signal diode 58 is attached to the housing 34. More specifically, the second signal diode 58 is attached to the first side portion 38 of the housing 34. The second signal diode 58 is configured for emitting light at a second wavelength 68, perpendicular to the slotted wheel 44. Accordingly, the light emitted from the second signal diode 58 passes through slots 48 in the slotted wheel 44 as the slotted wheel 44 rotates past the housing 34 and the second signal diode 58.

The second sensor diode 62 is disposed opposite the slotted wheel 44 from the second signal diode 58. The second sensor diode 62 is attached to the housing 34. More specifically, the second sensor diode 62 is attached to the second side portion 40 of the housing 34. The second sensor diode 62 is configured for receiving the light emitted from the second signal diode 58 through the plurality of slots 48. Because the second sensor diode 62 is directly opposite the second signal diode 58, the second sensor diode 62 only receives light from the second signal diode 58 when one of the slots 48 is directly between the second signal diode 58 and the second sensor diode 62. As shown, the second signal diode 58 and the second sensor diode 62 are disposed across the second group of slots 54, such that light emitted from the second signal diode 58 must pass through the second group of slots 54 to reach the second sensor diode 62.

The second signal diode 58 may include but is not limited to a Light Emitting Diode (LED). As noted above, the second signal diode 58 emits light at the second wavelength 68. The second wavelength 68 is different from the first wavelength 64. Preferably, the second signal diode 58 emits a visible blue light having a wavelength between four hundred fifty nanometers (450 nm) and four hundred ninety nanometers (490 nm). More preferably, the second signal diode 58 emits a light having a wavelength approximately equal to four hundred seventy nanometers (470 nm).

The second sensor diode 62 includes a PIN diode. The second sensor diode 62 further includes a wavelength filter, such as but not limited to a second band pass filter 70. The second band pass filter 70 is configured to filter out light that is outside the visible blue light range. Preferably, the second band pass filter 70 filters out light having a wavelength outside the range four hundred fifty nanometers (450 nm) and four hundred ninety nanometers (490 nm). Accordingly, only light having a wavelength between the range of four hundred fifty nanometers (450 nm) and four hundred ninety nanometers (490 nm) may pass through the second band pass filter 70 and reach the PIN diode of the second sensor diode 62.

As described above, the first signal diode 56 and the second signal diode 58 are attached to the first side portion 38, and the first sensor diode 60 and the second sensor diode 62 are attached to the second side portion 40. The slotted wheel 44 is rotatable relative to the first signal diode 56, the second signal diode 58, the first sensor diode 60 and the second sensor diode 62. In operation, the slotted wheel 44 rotates about the longitudinal axis 46 with the shaft 28, such that the first group of slots 52 rotates past the first signal diode 56 and the first sensor diode 60, and the second group of slots 54 rotates past the second signal diode 58 and the second sensor diode 62. The wavelength filter of the first sensor diode 60, i.e., the first band pass filter 66, filters out all stray light emitted from the second signal diode 58 so that the first sensor diode 60 only receives the light emitted from the first signal diode 56. Similarly, the wavelength filter of the second sensor diode 62, i.e., the second band pass filter 70, filters out all stray light emitted from the first signal diode 56 so that the second sensor diode 62 only receives the light emitted from the second signal diode 58. Because the stray light from the first signal diode 56 is filtered out to not affect the second sensor diode 62, and the stray light from the second signal diode 58 is filtered out to not affect the first sensor diode 60, the optical encoder 22 described herein is suitable for use in an open or wet environment, such as within the transmission assembly 20 depicted in FIG. 1, and does not need to be sealed within a clean environment.

Referring to FIGS. 4 and 5, an alternative embodiment of the optical encoder is generally shown at 80 in FIG. 4. The optical encoder 80 includes the first signal diode 56, the second signal diode 58, the first sensor diode 60 and the second sensor diode 62 as described above with reference to FIGS. 1 through 3. The optical encoder 80 positions all of the first signal diode 56, the second signal diode 58, the first sensor diode 60 and the second sensor diode 62 radially equidistant from a center 86 of a slotted wheel 82.

Referring to FIG. 5, the slotted wheel 82 defines a plurality of slots 84. The slots 84 extend radially outward from the center 86 of the slotted wheel 84, and are disposed angularly about the center 86 of the slotted wheel 84. The slots 84 in the slotted wheel 82 rotate through a channel 88, shown in FIG. 4, past the first signal diode 56, the second signal diode 58, the first sensor diode 60 and the second sensor diode 62. Each of the slots 84 in the slotted wheel 82 includes a first edge 100 and a second edge 102 defining a slot width 90 therebetween. The first signal diode 56 and the first sensor diode 60 are aligned opposite each other across the channel 88 along a first axis 92. The second signal diode 58 and the second sensor diode 62 are aligned opposite each other across the channel 88 along a second axis 94. The first axis 92 and the second axis 94 are laterally spaced from each other a diode width 96.

The slot width 90 and the diode width 96 are sized so that as the slots 84 rotate past the diodes, a sequence is established. The sequence includes the first sensor diode 60 receiving a signal from the first signal diode 56 through one of the slots 84 while the second sensor diode 62 is blocked from receiving a signal from the second signal diode 58 by the slotted wheel 82, followed by both the first sensor diode 60 and the second sensor diode 62 receiving signals through one of the slots 84 from the first signal diode 56 and the second signal diode 58 respectively, followed by the first sensor diode 60 being blocked from receiving a signal from the first signal diode 56 by the slotted wheel 82, while the second sensor diode 62 receives a signal from the second signal diode 58 through one of the slots 84. This sequence is repeated for each of the slots 84 of the slotted wheel 82.

While the best modes for carrying out the invention have been described in detail, those familiar with the art to which this invention relates will recognize various alternative designs and embodiments for practicing the invention within the scope of the appended claims.

1. An optical encoder comprising:
a slotted wheel defining a plurality of slots extending radially outward from a center of the slotted wheel and disposed angularly about the center of the slotted wheel;
a first signal diode configured for emitting light at a first wavelength perpendicular to the slotted wheel;
a first sensor diode disposed opposite the slotted wheel from the first signal diode, and configured for receiving the light emitted from the first signal diode through the plurality of slots;
a second signal diode configured for emitting light at a second wavelength perpendicular to the slotted wheel; and
a second sensor diode disposed opposite the slotted wheel from the second signal diode, and configured for receiving the light emitted from the second signal diode through the plurality of slots;
wherein the slotted wheel is rotatable relative to the first signal diode, the second signal diode, the first sensor diode and the second sensor diode; and
wherein the first wavelength is different from the second wavelength.

2. An optical encoder as set forth in claim 1 wherein the first signal diode and the second signal diode each include a Light Emitting Diode (LED).

3. An optical encoder as set forth in claim 2 wherein the first signal diode emits an infrared light.

4. An optical encoder as set forth in claim 3 wherein the first signal diode emits a light having a wavelength between seven hundred nanometers (700 nm) and fourteen hundred nanometers (1,400 nm).

5. An optical encoder as set forth in claim 4 wherein the first signal diode emits a light having a wavelength approximately equal to eight hundred seventy nanometers (870 nm).

6. An optical encoder as set forth in claim 3 wherein the second signal diode emits a visible blue light.

7. An optical encoder as set forth in claim 6 wherein the second signal diode emits a light having a wavelength between four hundred fifty nanometers (450 nm) and four hundred ninety nanometers (490 nm).

8. An optical encoder as set forth in claim 7 wherein the second signal diode emits a light having a wavelength approximately equal to four hundred seventy nanometers (470 nm).

9. An optical encoder as set forth in claim 6 wherein the first sensor diode and the second sensor diode each include a PIN diode.

10. An optical encoder as set forth in claim 9 wherein the first sensor diode includes a first band pass filter configured for filtering light outside the infrared range.

11. An optical encoder as set forth in claim 10 wherein the first band pass filter filters light having a wavelength outside the range of seven hundred nanometers (700 nm) and fourteen hundred nanometers (1,400 nm).

12. An optical encoder as set forth in claim 10 wherein the second sensor diode includes a second band pass filter configured for filtering light outside the visible blue light spectrum.

13. An optical encoder as set forth in claim 12 wherein the second band pass filter filters light having a wavelength outside the range of four hundred fifty nanometers (450 nm) and four hundred ninety nanometers (490 nm).

14. An optical encoder as set forth in claim 1 wherein the housing defines a channel having a first side portion and a second side portion parallel with and spaced from the first side portion a channel width, with the first signal diode and the second signal diode attached to the first side portion, and the first sensor diode and the second sensor diode attached to the second side portion.

15. An optical encoder as set forth in claim 14 wherein the plurality of slots in the slotted wheel rotate through the channel.

16. An optical encoder as set forth in claim 15 wherein the channel width is between the range of four millimeters (4 mm) and 8 millimeters (8 mm).

17. An optical encoder as set forth in claim 16 wherein the channel width is approximately equal to six millimeters (6 mm).

18. An optical encoder as set forth in claim 1 wherein the plurality of slots includes a first group of slots and a second group of slots, wherein the first group of slots is disposed radially farther from the center of the slotted wheel than the second group of slots, and wherein the first signal diode is positioned relative to the slotted wheel to emit light through the first group of slots, and the second signal diode is positioned relative to the slotted wheel to emit light through the second group of slots.

19. An optical encoder comprising:
a housing;
a slotted wheel defining a plurality of slots extending radially outward from a center of the slotted wheel and disposed angularly about the center of the slotted wheel, wherein the slotted wheel is rotatable relative to the housing;
a first signal diode attached to the housing and configured for emitting light at a first wavelength perpendicular to the slotted wheel, wherein the first wavelength includes a wavelength between the range of seven hundred nanometers (700 nm) and fourteen hundred nanometers (1,400 nm);
a first sensor diode disposed opposite the slotted wheel from the first signal diode, and configured for receiving the light emitted from the first signal diode through the plurality of slots, wherein the first sensor diode includes a first band pass filter configured for filtering out light having a wavelength outside the range of seven hundred nanometers (700 nm) and fourteen hundred nanometers (1,400 nm);
a second signal diode attached to the housing and configured for emitting light at a second wavelength perpendicular to the slotted wheel, wherein the second wavelength is between the range of four hundred fifty nanometers (450 nm) and four hundred ninety nanometers (490 nm); and
a second sensor diode disposed opposite the slotted wheel from the second signal diode, and configured for receiving the light emitted from the second signal diode through the plurality of slots, wherein the second sensor diode includes a second band pass filter configured for filtering out light having a wavelength outside the range of four hundred fifty nanometers (450 nm) and four hundred ninety nanometers (490 nm).

20. An assembly comprising:
an outer shell defining a closed interior and rotatably supporting a shaft within the closed interior;
a fluid disposed within the closed interior; and
an optical encoder disposed within the closed interior and coupled to the shaft for sensing a position of the shaft, the optical encoder including:
a slotted wheel defining a plurality of slots extending radially outward from a center of the slotted wheel and disposed angularly about the center of the slotted wheel, wherein the slotted wheel is rotatable with the shaft;
a first signal diode configured for emitting light at a first wavelength perpendicular to the slotted wheel, wherein the first wavelength includes a wavelength between the range of seven hundred nanometers (700 nm) and fourteen hundred nanometers (1,400 nm);
a first sensor diode disposed opposite the slotted wheel from the first signal diode, and configured for receiving the light emitted from the first signal diode through the plurality of slots, wherein the first sensor diode includes a first band pass filter configured for filtering out light having a wavelength outside the range of seven hundred nanometers (700 nm) and fourteen hundred nanometers (1,400 nm);
a second signal diode configured for emitting light at a second wavelength perpendicular to the slotted wheel, wherein the second wavelength is between the range of four hundred fifty nanometers (450 nm) and four hundred ninety nanometers (490 nm); and
a second sensor diode disposed opposite the slotted wheel from the second signal diode, and configured for receiving the light emitted from the second signal diode through the plurality of slots, wherein the second sensor diode includes a second band pass filter configured for filtering out light having a wavelength outside the range of four hundred fifty nanometers (450 nm) and four hundred ninety nanometers (490 nm).
